(19) United States
(12) Patent Application Publication
(10) Pub. No.: US 2024/0354673 A1
(43) Pub. Date: Oct. 24, 2024

(54) INTELLIGENT RESOURCE MONITORING AND TRACKING SYSTEM

(71) Applicant: LEWIS WOOLCOTT PTY LTD, Milton, QLD (AU)

(72) Inventor: John LEWIS, Milton (AU)

(21) Appl. No.: 18/683,177

(22) PCT Filed: Aug. 10, 2022
(86) PCT No.: PCT/AU2022/050872

§ 371 Date: Feb. 12, 2024

(30) Foreign Application Priority Data
Aug. 10, 2021 (AU) 2021902485

(51) Int. Cl. G06Q 10/0631; H04W 4/029

(52) U.S. Cl. CPC G06Q 10/063114; G06Q 10/06313; H04W 4/029

(57) ABSTRACT

A system is provided that is able to monitor project resources, such as plant and workers, in near real-time or historically, in a project. The system includes: a plurality of tracking devices, for tracking each of a plurality of project resources, each of the plurality of tracking devices associated with a resource category; and a server configured to receive tracking data from each of the tracking devices and associate the tracking data with the resource category of the associated tracking device. The server is configured to generate a graphical user interface to display the data associated with the received tracking data according to the resource category.

### TECHNICAL FIELD

The present invention relates to the monitoring and tracking of resources. In particular, the present invention relates to near real-time and historical tracking of resources in a project.

### BACKGROUND ART

In large projects, many resources generally work on the project in a coordinated manner. In large construction projects, this can include earthworks and structural work, for example, and often involves many workers and equipment.

A problem with management of such projects is that it is difficult to ensure that the project is running efficiently. When workers performing different tasks are working in the same area, inefficiencies and bottlenecks can occur, for example.

The use of area managers or foremen may be used to manually monitor workers, to ensure that any inefficiencies and bottlenecks are identified and resolved. A problem with the use of such managers is that their work requires a physical presence at the site and is therefore labour intensive, and it is difficult for such managers to get a good overview of a project when it is split over a wide geographic area.

Other problems with projects covering large geographic areas, particularly in remote locations, is that it is difficult to get an overview of where workers and plant or equipment are located at a particular point in time. This not only relates to efficiency, but is also important from a safety or cultural heritage protection perspective.

Certain tools exist, such as GPS trackers, for tracking the location of persons or plant. A problem with such tools is that they are not easy to use in large projects, as they result in large amounts of difficult to process data.

Another problem with management of large projects is that it can be difficult to determine the impact of events on a project. For example, a rain event may delay earthworks more than other areas, but it is difficult to quantify to what extent different aspects of the project are delayed.

As it is difficult to analyse a project in great detail, heuristics are often used, where past project delay impacts are used to estimate delay impacts on the project. A problem with such approach is that it is inaccurate, and does not take into account specific details of the present project, and therefore will result in under or over estimation.

As such, there is clearly a need for improved resource monitoring and tracking systems.

It will be clearly understood that, if a prior art publication is referred to herein, this reference does not constitute an admission that the publication forms part of the common general knowledge in the art in Australia or in any other country.

### SUMMARY OF INVENTION

The present invention relates resource monitoring and tracking systems, which may at least partially overcome at least one of the abovementioned disadvantages or provide the consumer with a useful or commercial choice.

With the foregoing in view, the present invention in one form, resides broadly in a system for monitoring project resources, the system including:
a plurality of tracking devices, for tracking each of a plurality of project resources, each of the plurality of tracking devices associated with a resource category; and
a server configured to receive tracking data from each of the tracking devices and associate the tracking data with the resource category of the associated tracking device; wherein the server is configured to generate a graphical user interface to display the data associated with the received tracking data according to the resource category.

Advantageously, the system enables near real-time and historical tracking of resources, such as plant and workers, in a project. This enables various tasks to be performed including efficiency analysis and delay impact quantification. The system enables monitoring of project resources according to resource categories, which enables simple analysis to be performed, e.g. relating to site efficiency or the impact of events on the project.

Preferably, the graphical user interface is configurable to display a heat map of the project resources. The heat map may display a concentration of resources with reference to a map. The map may comprise or include a satellite image of an area.

The heat map may be configured to display a concentration of resources with reference to a resource category. The resource categories may be colour coded on the heat map, wherein a colour intensity or opacity is used to indicate concentration.

The heat map may be configured to display concentrations of over lapping resource categories. Over lapping resource categories may be illustrative of an inefficiency in the execution of project works.

Preferably, the system is configured to determine one or more metrics of movement of the project resources. The one or more metrics of movement of the project resources may be displayed on the graphical user interface. The one or more metrics of movement of the project resources may be displayed with reference to a timeline.

The project resources may include workers. The project resources may include plant or equipment.

The tracking devices may include a GPS sensor, configured to determine a location of the tracking device (and thereby project resource) according to data from satellites.

The tracking devices may be allocated to project resources on an ad-hoc basis, without linking the individual tracking devices to particular project resources.

The resource category may be displayed on the tracking device. The resource category may be colour coded onto the tracking device. Such feature enables workers associated with a particular category to simply take a tracking device that is associated with their category.

The tracking devices may be battery powered. The tracking devices may be recharged each day. The tracking devices maybe plug and play into a standard car port such as USB or OBD2. The tracking devices maybe hardwired to the vehicle battery.

The tracking devices may be configured to wirelessly communicate the tracking data to the server. The tracking devices may be configured to communicate the tracking data at least in part using a cellular network. The tracking devices may be configured to use Long Range Wide Area Networks (LoRaWAN).

The tracking device may be configured to periodically log location data, and associate the location data with a timestamp.

The tracking devices may be configured to provide an identifier of a resource category to the server.

The tracking devices may be reconfigurable to be associated with different resource categories. The tracking devices may be reconfigurable at the tracking device itself, e.g. with reference to a button or user interface.

The graphical user interface may be configured to enable selection of resource categories for display, e.g. with reference to a heat map or as points. Such configuration enables drilling down into particular project categories.

The graphical user interface may be configured to enable one or more geo-fences to be defined, each geofence defining an area. The system may be configured to perform analysis and/or display data according to a defined area. As an illustrative example, the work zones may be defined using geo-fences such that tracking data may be processed according to work zone.

The system may monitor one or more metrics of movement of the project resources with reference to a project plan or schedule. The system may monitor the metrics of movement of the project resources with reference to a project plan or schedule for a particular work zone or group of work zones. The system may determine a disparity between the project plan or schedule and the metrics of movement of the project resources, and issue an alert or notification according thereto.

The geo-fences may define forbidden areas, wherein an alert is issued if a tracking device enters a forbidden area. The forbidden areas may include dangerous areas and culturally significant areas.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Various embodiments of the invention will be described with reference to the following drawings, in which:

FIG. 1 illustrates a schematic of project resource tracking system, according to an embodiment of the present invention.

FIG. 2 illustrates a screenshot of a mapping screen of the system of FIG. 1, according to an embodiment of the present invention.

FIG. 3 illustrates a screenshot of a data selection screen of the system of FIG. 1, according to an embodiment of the present invention.

FIG. 4 illustrates a map element, similar to a map element of the mapping screen of FIG. 2, according to an embodiment of the present invention.

FIG. 5a illustrates a screenshot of a map element and associated data table, illustrating a part of a site before an event, showing resources working efficiently.

FIG. 5b illustrates a screenshot of a map element and associated data table, illustrating the same part of the site as FIG. 5a, but during a storm event.

FIG. 5c illustrates a screenshot of a map element and associated data table, illustrating the same part of the site as FIGS. 5a and 5b, but two days after the storm event.

FIG. 5d illustrates a screenshot of a map element and associated data table, illustrating the same part of the site as FIGS. 5a, 5b and 5c, but seven days after the storm event.

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way.

### DESCRIPTION OF EMBODIMENTS

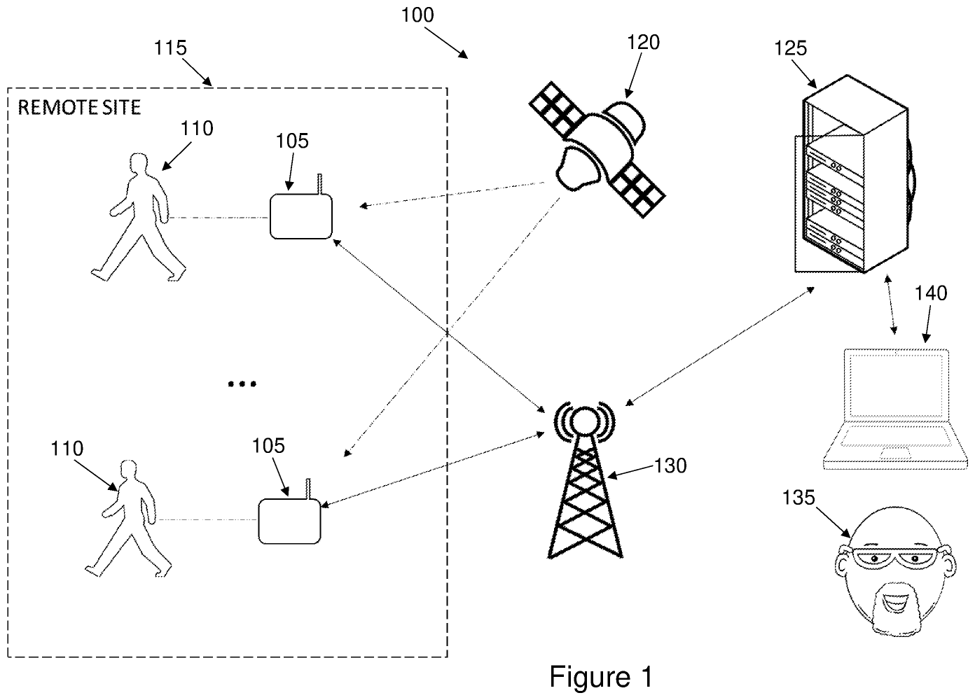

FIG. 1 illustrates a schematic of project resource tracking system 100, according to an embodiment of the present invention. The project resource tracking system 100 enables near real-time and historical tracking of resources, such as plant and workers, in a project.

The project resource tracking system 100 includes a plurality of GPS tracking devices 105, each associated with a worker 110 working at a remote site 115. The workers 110 are resources themselves, and are also associated with physical resources, such as plant, machines and equipment.

Each of the GPS tracking devices 105 includes a unique identifier, uniquely identifying the device 105, and a group identifier, identifying a group of device 105. The group identifier may be in the form of colour coding, where the plurality of GPS tracking devices are grouped according to colour.

In use, the GPS tracking devices 105 are carried by the workers 110 while they are working. The GPS tracking devices 105 determine accurate location data based upon signals from GPS satellites 120, such as coordinates, as is known in the field of geo-positioning. This location data is associated with timestamps and sent to a report server 125 using a wireless cellular network 130, such as a 4G or 5G data network, along with the unique identifier and the group identifier.

The server 125 is then able to log the movement of the GPS tracking devices 105 over time, both individually for each GPS tracking device 105, and for groups of GPS tracking devices 105 according to the group identifier. This may then be displayed to an analyst 135 using a graphical user interface and a computer device 140 coupled to the server 125, as outlined in further detail below.

The GPS tracking devices 105 may be colour coded according to a plurality of different project categories relating to the project, such as structural work, earthworks and pavement. The skilled addressee will however, readily appreciate that different types of projects will include different project categories, and that different project categories may be chosen for a project according to what is desired to be monitored.

At the start of a shift, the workers 110 may each take a GPS tracking device 105 that is colour coded according to his or her project category. Between shifts, the GPS tracking devices 105 are returned, e.g. to a docking or charging station, resulting in different GPS tracking devices 105 being used by different workers 110 on different shifts. Such configuration provides monitoring according to function or category, without tracking individual workers 110, thereby alleviating privacy issues that may be associated with personal tracking.

During a shift, data is uploaded to the server 125 from all of the GPS tracking devices 105, as the data is captured. This data shows a location of each of the GPS tracking devices 105 over time, which can be used to determine movement and other information.

The system 100 logs this data in association with the project activity and enables interactive display of this data in the graphical user interface with reference to a map. This is useful in determining efficiencies of the project, as well as analysing work zone activity.

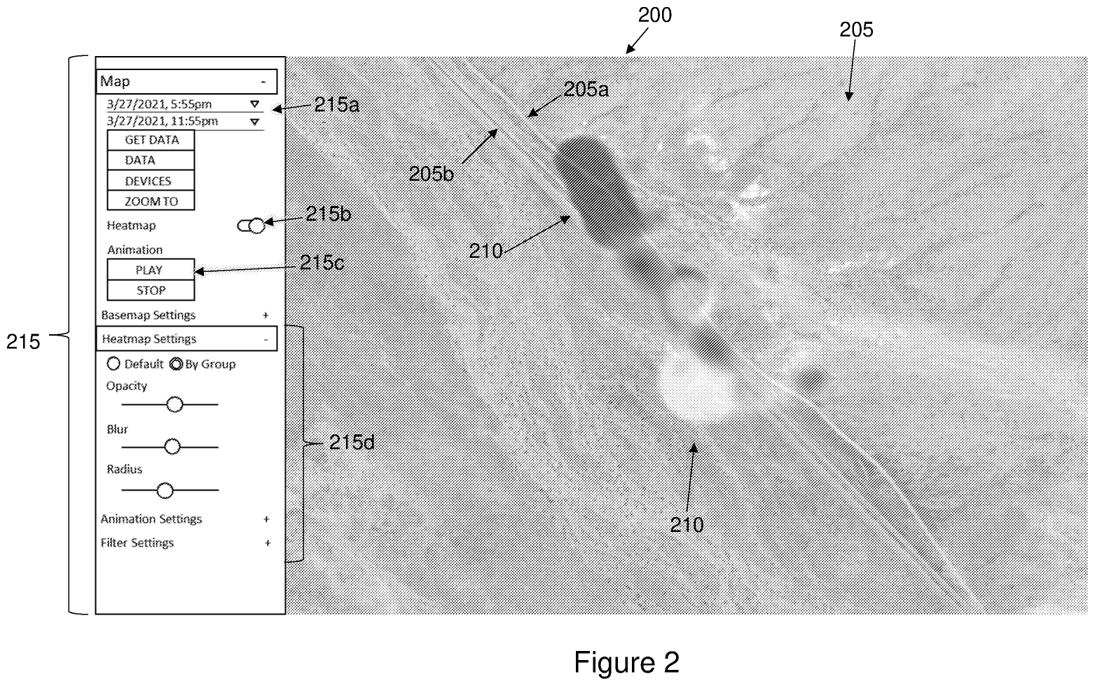

FIG. 2 illustrates a screenshot 200 of mapping screen of the system 100, according to an embodiment of the present invention.

The mapping screen includes a map element 205, on which project activity data is displayed as colour-coded heat maps 210. The map element 205 is displayed in the form of a satellite image in which roads 205a and railway tracks 205b are visible.

The mapping screen further includes a menu 215, for enabling the analyst 135 to interact therewith.

The menu 215 includes a time element 215a, defining a time (or time period) for which data is to be displayed. If a single time is chosen, data is presented for that time. If a time period is selected, an animation showing the movement of project resources during that time period may be shown.

A heatmap toggle 215b is provided in the menu, which enables the analyst 135 to toggle between data being displayed as individual elements, where points are shown for each of the plurality of GPS tracking devices 105, or as a heatmap, where colour intensity is used to show a density of GPS tracking devices 105 in a particular project category.

The menu 215 further includes animation buttons 215c enabling the analyst 135 to stop and start animations. This is particularly useful when the analyst 135 wishes to stop partway through an animation to consider the data at a particular point of time.

Time lapse animations are useful to show the progression of resource activity, allowing the analyst 135 to quickly identify ‘hot’ and ‘cold’ activity spots.

Finally, the menu 215 further includes heatmap settings elements 215d, which enable the analyst 135 to adjust how the heatmap is to be displayed, including opacity of the heatmap, blur and radius.

The system 100 further enables the analyst 135 to configure how the heatmap 210 itself is displayed with reference to the project categories. In particular, the heatmap 210 may be configured such that each of the project categories is colour coded, and intensity or transparency is used to illustrate concentration. Alternatively, the heatmap 210 may be configured such that colour coding is used to illustrated concentration of GPS tracking devices (regardless of what project category they are part of).

The graphical user interface will include a variety of other features, including the ability to pan and zoom, as well as adjust a variety of other display parameters, as will be readily appreciated by the skilled addressee.

In addition to enabling the analyst 135 to configure how the data is displayed, the system further enables the analyst to select what data is displayed. This enables the analyst to go from a broad overview of a site, and drill down into specific categories of data to gain insight therefrom.

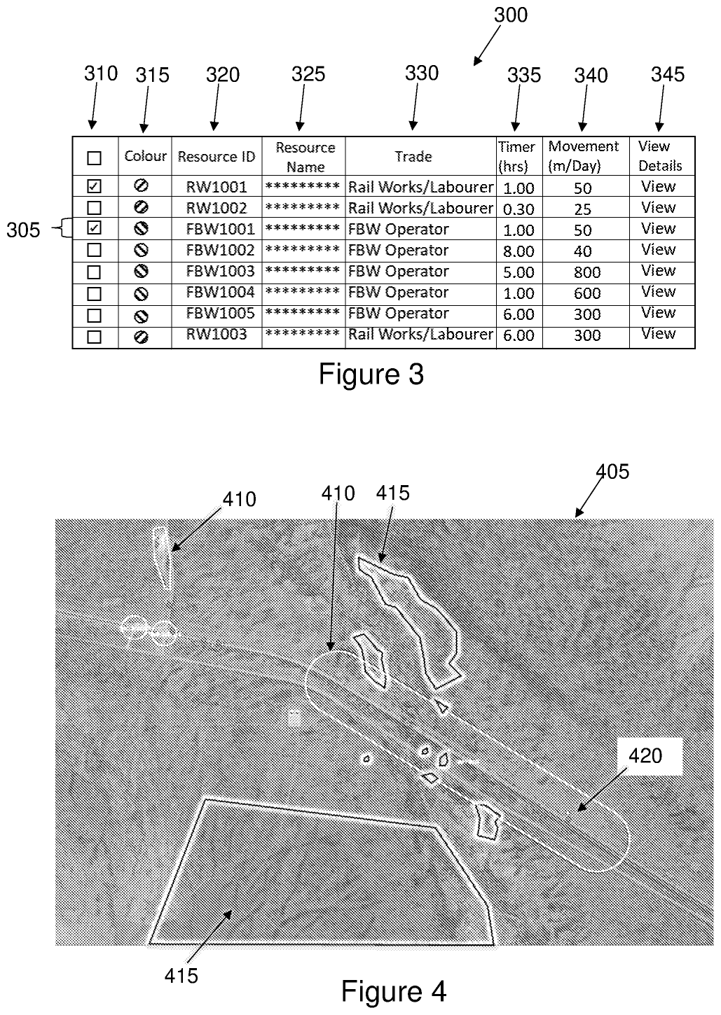

FIG. 3 illustrates a screenshot 300 of a data selection screen of the system 100, according to an embodiment of the present invention. The data selections screen enables the analyst 135 to select data for display, upon which the mapping screen is updated to display the selected data.

The data selections screen comprises a table including a plurality of rows 305, each relating to a group of data available for selection. The data may be grouped according to project category, such that project categories may be turned on and off, or comprise individual units for selection.

Each row 305 includes a display selection checkbox 310, enabling the data associated with the row to be selected for display. Each row 305 includes plurality of data fields, enabling simple identification of the associated project resources, including a colour field 315, an identifier field 320, a resource name field 325, a trade field 330, a timer field 335, and a movement field 340, illustrating the colour coding, an identifier, a name, a trade category, a timer and movement associated with the resource.

Finally, each row 305 includes a view details button 345, enabling the analyst 135 to get further detail on the resource.

The data selection screen enables the analyst 135 to start with general data of the project, and drill down on specific categories (e.g. onto a particular trade). The mapping screen enables the analyst to easily see the precise location of trades, plant and equipment, and the data selection screen enables the analyst 135 to home in on a specific resource or resource groups to see resource movement over time and identify under-utilisation.

The system 100 further enables the analyst to analyse movement of project resources, such as workers 110. This is particularly useful in identifying productivity, as it provides a simple way of distinguishing between workers simply being present on a site and actually working on a site.

The system 100 may determine differences in tracking data over time to determine movement of the resource. This is particularly relevant when tracking data is provided at high resolution (in time), as movement is able to be accurately determined.

If a particular category of project resources typically moves a certain amount (e.g. 800m per day), and suddenly goes down to a much lower level, the system 100 may issue an alert to the analyst 135. The analyst 135 may then investigate that particular resource, e.g. by drilling down on that resource category using the data selection screen.

The system 100 may also be configured to display movement over time, e.g. using a chart, to determine past periods of inefficiency, or repetitive patterns of inefficiency, with a view of improving efficiency in these areas.

As an illustrative example, trains passing through construction areas may slow construction progress. The system 100 enables the quantification of delayed construction progress and analysis of data can improve future construction productivity through enhanced scheduling and forecasting.

In addition to enabling selection of project resources based upon resource category, the system 100 enables definition of work zones, each of which may be analysed. In such case, a geo-fence (virtual perimeter) may be defined with reference to a map or region. The system may then analyse resources within the defined area. Multiple work zones can be established for geographically dispersed projects, as outlined below.

Similarly, virtual exclusion zones may be defined in a similar manner. In such case, the system may be configured to issue an alert when a project resources enters an exclusion zone.

FIG. 4 illustrates a map element 405, similar to the map element 205, but including a plurality of defined zones.

The map element includes a plurality of work zones 410 and a plurality of exclusion zones 415. The map element further includes a plurality of resource items 420, corresponding to individual project resources.

Individual work zones 410 may be analysed in a similar manner to that described above, but only with reference to the chosen work zone 410. In such case, the analyst 135 may identify problems with a particular work zone 410, to increase efficiency thereof.

Furthermore, workers efficiency in each of the work zones 410 may be analysed and compared. Similarly, work in different areas may be mapped to different items in a project schedule. Therefrom, adherence to a project schedule may be determined with reference to actual movement in work zones, rather than delayed reporting.

The system may monitor real movement of people and plant and compare this with a planned number of role-based hours required to complete a given task, as defined by a project plan or schedule, or part thereof. This monitoring may be performed for a particular work zone 410, or group of work zones 410, and compared to scheduled data for that work zone 410, or group of work zones 410.

Any discrepancy between planed workforce data and actual workforce data may be reported by the system in the form of an alert or suitable notification. Similarly, key lead indicators relating to project outcome may be streamed in near real time, such as Comparative Hours Burned for each resource type in accordance to work zone criticality.

Based off this information, timely decisions can be made on corrective action, mitigating the risk of project execution failure.

The work zones may be subdivided into sub work zones, and the sub work zones may correspond to sub-items in a Work Breakdown Structure (WBS) of the project schedule. This enables analysis to be performed in various levels, which may in turn identify specific areas requiring corrective action.

The work zones 410 and exclusion zones 415 may be defined directly in the graphical user interface, e.g. by drawing the zone (geo-fence) on the map element. A range of tools may exist to assist the analyst 135 for such purpose, including geometric drawing tools and the like.

Exclusion zones may be defined for a number of reasons, and may be configured according to project resource category. As an illustrative example, a particular zone may exclude all workers and resources except for crane drivers and slingers. All other resource categories would in such case be non-permitted, and an alarm or alert would issue if non-permitted persons enter the exclusion zone.

The alerts may issue immediately upon entry of an exclusion zone by a non-authorised worker, or when a non-authorised worker enters such zone for longer than a predefined period (e.g. for greater than 5 minutes). The GPS tracking devices may signal an alarm and/or vibrate, alerting the worker that they have entered an exclusion zone.

Examples of exclusion zones may include; areas of contamination, high voltage electricity, lifting operations, heavy haul routes and rail lines. Similarly, exclusion zones may comprise cultural heritage sites, where the virtual exclusion zone is established to protect and monitor areas of cultural or environmental significance.

The use of geo-fences to define virtual exclusion zones in such manner reduces the requirement for physical barriers, which can be costly when large areas are excluded or protected.

As outlined above, the system 100 is particularly suited for efficiency analysis. In such case, the heat maps may be used to identify inefficient work procedures, which may be improved. By using colour coding to display trade concentration by location, the analyst is able to quickly and intuitively identify patterns of behaviour or inefficiencies. As an illustrative example, overlapping or deep colours (high concentration) may suggest trade saturation, resulting in inefficiency. Similarly, areas which are scheduled for work, but have no or little activity, may be flagged for further analysis, identifying potential delays as they are happening rather than afterwards.

The system 100 is also particularly suited for analysing the actual effects of disruption on a project. In particular, the system may demonstrate resource movements before, during and after an event, clearly quantifying resource downtime using time-lapsed resource analysis.

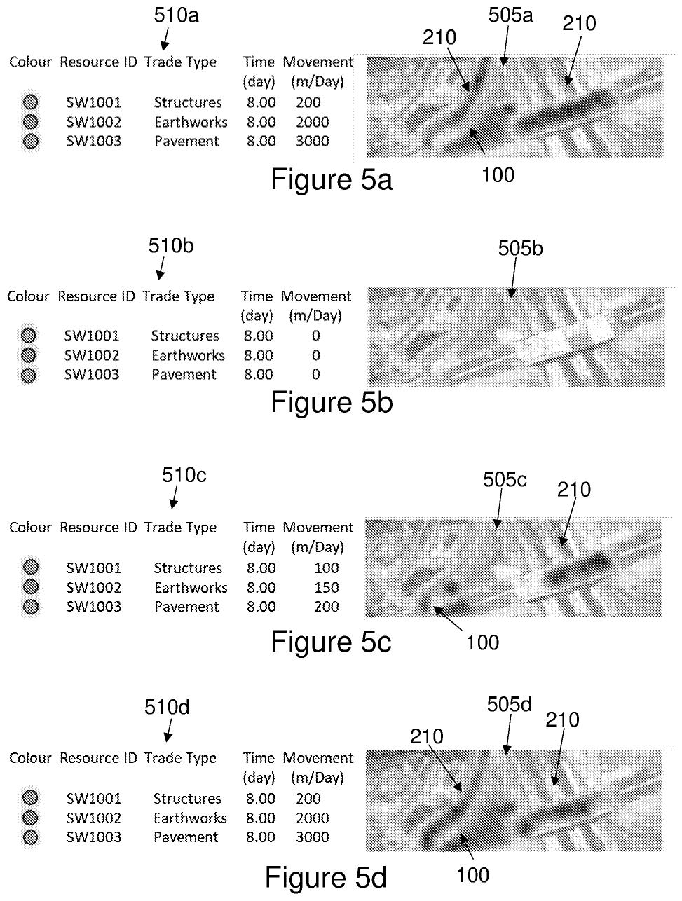

FIGS. 5a-5d illustrate an example of such analysis of project disruption, where wet weather has caused delay and disruption to a construction project.

FIG. 5a illustrates a screenshot of a map element 505a and associated data table 510a, illustrating a part of a site before an event, showing resources working efficiently. The map element 505a and data table 510a shows structural, earthworks and pavement workers working on the project, and associated movement data.

FIG. 5b illustrates a screenshot of a map element 505b and associated data table 510b, illustrating the same part of the site as FIG. 5a, but during a storm event. The map element 505b and data table 510b shows no work activity in the area, and no movement.

FIG. 5c illustrates a screenshot of a map element 505c and associated data table 510c, illustrating the same part of the site as FIGS. 5a and 5b, but two days after the storm event. The map element 505c and data table 510c shows some (reduced) work activity in the area, with heavily reduced movement data.

Finally, FIG. 5d illustrates a screenshot of a map element 505d and associated data table 510d, illustrating the same part of the site as FIGS. 5a, 5b and 5c, but seven days after the storm event. The map element 505c and data table 510c show that the site has returned back to normal activity, similar to that of prior to the event.

As the system 100 enables data to be displayed and analysed according to category, the analyst 135 is able to easily segregate resources undertaking repairs or clean up from those productively working on the project. This is essential to identify insurance activity from potential extension of time entitlement.

The skilled addressee will readily appreciate that a wide range of variations may be made, without departing from the scope of invention, including as outlined below.

In some embodiments, particularly when working in remote areas, cellular networks may not be directly available. In such case, a cellular repeater or portable cellular to satellite base station may be used to provide connectivity to the GPS tracking devices 105. In some embodiments, several repeaters may be used together to form a mesh network.

Furthermore, while each GPS tracking device 105 may be associated with a project resource group, and such group may be provided to the server, in other embodiments the server may include a mapping between individual identifiers of GPS tracking devices 105 and groups.

The system 100 enables workers to be tracked as groups, while maintaining privacy and anonymity of individual workers. This is due to the fact that individual workers need not be associated with individual GPS tracking devices 105. In other embodiments, however, GPS tracking devices 105 may be directly associated with workers. The skilled addressee will readily appreciate that in such case local privacy laws would need to be complied with and suitable consent obtained, where required.

The system 100 will also be generally configured to enable the export of data, e.g. to support findings in a report, or any suitable purpose. In such case, the data may be filtered and exported into a standardised format, to allow easy integration with other systems.

In addition to measuring the impacts and effects of delays, and identifying inefficiencies, the system 100 may be used for a wide range of other applications, including safety, where workers may be located in an emergency, automated record keeping, trade interface control, comparing planned and actual resources, emergency warning and disaster coordination and control, and program activity verification.

Advantageously, the systems and methods disclosed herein enable near real-time and historical tracking of resources, such as plant and workers, in a project. This enables various tasks to be performed including efficiency analysis and delay impact quantification.

The systems and methods have the ability to track workers and resources without storing personal data, and therefore may be used in areas where worker consent is not provided, or privacy laws do not allow such personally identifiable tracking.

The systems and methods display data in an intuitive manner, which enables a quick overview of a project to be obtained, while enabling the drilling down into specific areas of a project.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A system for monitoring project resources, the system including:
a plurality of tracking devices, for tracking each of a plurality of project resources, each of the plurality of tracking devices associated with a resource category; and
a server configured to receive tracking data from each of the tracking devices and associate the tracking data with the resource category of the associated tracking device;
wherein the server is configured to generate a graphical user interface to display the data associated with the received tracking data according to the resource category.

2. The system of claim 1, wherein the graphical user interface is configurable to display a heat map of the project resources, the heat map displaying a concentration of resources with reference to a resource category.

3. The system of claim 2, wherein the heat map is configured to display a concentration of resources with reference to a resource category.

4. The system of claim 3, wherein the resource categories are colour coded on the heat map, wherein a colour intensity or opacity is used to indicate concentration.

5. The system of claim 2, wherein the heat map is configured to display concentrations of over lapping resource categories.

6. The system of claim 1, further configured to determine one or more metrics of movement of the project resources based upon the received tracking data.

7. The system of claim 6, wherein the one or more metrics of movement of the project resources are displayed on the graphical user interface and with reference to a timeline.

8. The system of claim 1, wherein the project resources include workers and/or plant and/or equipment.

9. The system of claim 1, wherein the tracking devices include GPS sensors, configured to determine a location of the tracking device, and thereby a project resource, according to data from satellites.

10. The system of claim 1, wherein the tracking devices are allocated to project resources on an ad-hoc basis, without linking the individual tracking devices to particular project resources.

11. The system of claim 10, wherein the resource category is displayed on the tracking device, e.g. using colour coding.

12. The system of claim 1, wherein the tracking devices are battery powered.

13. The system of claim 1, wherein the tracking devices are configured to wirelessly communicate the tracking data to the server, e.g. using a cellular network or Long Range Wide Area Network (LoRaWAN).

14. The system of claim 1, wherein the tracking devices are configured to periodically log location data, and associate the location data with a timestamp.

15. The system of claim 1, wherein the tracking devices are configured to provide an identifier of a resource category to the server.

16. The system of claim 1, wherein the tracking devices are reconfigurable to be associated with different resource categories, e.g. with reference to a button or user interface.

17. The system of claim 1, wherein the graphical user interface is configured to enable selection of resource categories for display, e.g. with reference to a heat map or as points.

18. The system of claim 1, wherein the graphical user interface is configured to enable one or more geo-fences to be defined, each geofence defining an area, wherein the system is configurable to perform analysis and/or display data according to a defined area.

19. The system of claim 1, wherein the geo-fences may further define forbidden areas, wherein an alert is issued if a tracking device enters a forbidden area, e.g. a dangerous or culturally significant area.

20. The system of claim 1, configured to monitor one or more metrics of movement of the project resources with reference to a project plan or schedule, and determine a disparity between the project plan or schedule and the metrics of movement of the project resources, and issue an alert or notification according thereto.
